(19) United States
(12) Patent Application Publication
(10) Pub. No.: US 2013/0337234 A1
(43) Pub. Date: Dec. 19, 2013

(54) METHOD OF BONDING TWO SURFACES AND STRUCTURE MANUFACTURED BY USING THE SAME

(71) Applicant: SAMSUNG ELECTRONICS CO., LTD., Suwon-si (KR)

(72) Inventors: Joon-sub SHIM, Yongin-si (KR); Joon-ho KIM, Seongnam-si (KR); Kak NAMKOONG, Seoul (KR); Chin-sung PARK, Yongin-si (KR)

(73) Assignee: Samsung Electronics Co., Ltd., Suwon-si (KR)

(21) Appl. No.: 13/737,642

(22) Filed: Jan. 9, 2013

(30) Foreign Application Priority Data
Jun. 18, 2012 (KR) 10-2012-0065165

(51) Int. Cl. B32B 38/00; B32B 3/26; B32B 7/04

(52) U.S. Cl. CPC B32B 38/0008; B32B 7/04; B32B 3/26
USPC 428/172; 156/273.3; 428/447

(57) ABSTRACT

A method of efficiently bonding two surfaces using nitrogen plasma, and a structure manufactured by using the same.

### CROSS-REFERENCE TO RELATED APPLICATIONS

This application claims the benefit of Korean Patent Application No. 10-2012-0065165, filed on Jun. 18, 2012, in the Korean Intellectual Property Office, the disclosure of which is incorporated herein in its entirety by reference.

### BACKGROUND

Microfluidic devices are being used in industry for a wide variety of applications. For example, microfluidic devices are being used for high throughput analysis. A microfluidic device includes a microstructure such as a channel and a chamber. Microfluidic devices are prepared by using various methods. For example, techniques of manufacturing a microstructure, such as lithography, etching, deposition, micromachining, and LIGA technique are being used to prepare microfluidic devices.

A microfluidic device may be fabricated by forming microstructures such as channels on different substrates and bonding these substrates. For example, a method of fabricating a microfluidic device by forming microstructures on two glass substrates and bonding the two glass substrates has been reported. Each of the substrates includes the whole or a portion of the microstructure.

In the manufacture of the microstructure, plastic has better processibility and is cheaper than glass. Thus, there is a need to develop a method of efficiently bonding a plastic and an elastomer such as polydimethylsiloxane (PDMS) in order to use the plastic as the material of the microstructure.

### SUMMARY

Provided are methods of efficiently bonding two surfaces, and a structure, such as a microfluidic device, manufactured by the method.

According to an aspect of the present invention, a method of bonding two surfaces includes: treating a first surface with nitrogen plasma; and bringing the first surface treated with the nitrogen plasma into contact with a second surface, in which the first surface is a surface of a plastic material, and the second surface is a surface of a siloxane-containing material.

According to another aspect of the present invention, a microfluidic device is provided, which includes a first plastic substrate having a first surface, a second plastic substrate having a second surface, and a polysiloxane layer disposed between the first substrate and the second substrate, in which the polysiloxane layer is bonded to the first surface of the first substrate and the second surface of the second substrate.

### BRIEF DESCRIPTION OF THE DRAWINGS

These and/or other aspects will become apparent and more readily appreciated from the following description of the embodiments, taken in conjunction with the accompanying drawings of which:

FIG. 1 is a graph illustrating wide-scan survey spectrum of a polystyrene substrate treated with plasma by using an X-ray photoelectron spectroscopy (XPS);

FIG. 2 shows graphs illustrating results of analyzing contents of carbon (A), oxygen (B), and nitrogen (C) of a polystyrene substrate treated with plasma by using an XPS;

FIG. 3 shows a polystyrene substrate-polydimethylsiloxane (PDMS) structure prepared according to an embodiment of the present invention;

FIGS. 4A, 4B, and 4C are graphs illustrating results of testing bonding intensities after immersing PS-PDMS structures prepared according to an embodiment of the present invention and a control PS-PDMS structure in water;

FIG. 5 schematically shows resistance against hydrolysis of a PDMS-PS bond formed by the treatment of nitrogen plasma or oxygen plasma;

FIG. 6 shows a method of preparing a microfluidic structure;

FIGS. 7A to 7C schematically show a microfluidic structure; and

FIGS. 8A and 8B schematically show a pump formed using film valves.

### DETAILED DESCRIPTION

Provided is a method of bonding two surfaces, which method includes treating a first surface with nitrogen plasma; and bringing the first surface treated with the nitrogen plasma into contact with a second surface, in which the first surface is a surface of a plastic material, and the second surface is a surface of a siloxane-containing material

The nitrogen plasma treatment may be facilitated by contacting a plasma of a nitrogen-containing compound to the first surface. The nitrogen-containing compound may be nitrogen (N₂) or ammonia (NH₃), or a combination thereof. The plasma may be generated by any suitable technique, such as by applying an electromagnetic field to the nitrogen or ammonia molecules. In one embodiment, the plasma treatment may be performed by applying an electromagnetic field to nitrogen-containing molecules to generate plasma and bringing the plasma into contact with the surface. The plasma may be generated at about 100° C. or less, for example, in a range of room temperature or about 25° C. to about 100° C.

The first surface may be a surface of a plastic material. The plastic may have a hydrophobic or hydrophilic surface, and examples of the plastic may include polyolefin such as polyethylene, polypropylene, and high density polyethylene (HDPE), thermoplastic elastomer (TPE), elastic polymer, fluoropolymer, polymethylmethacrylate (PMMA), polystyrene, polycarbonate (PC), cyclic olefin co-polymer (COC), polyethylene terephthalate (PET), polyvinyl chloride (PVC), acrylonitrile-butadiene-styrene (ABS), polyurethane (PUR), and any combination thereof.

One or more microstructures may be formed on the entire first surface, or a portion of the first surface. A microstructure is not limited to a structure having dimensions of micrometers, but indicates a structure having small dimensions. For example, a microstructure may have at least one cross-section, i.e., diameter, width, and height, having dimensions of about 10 nm to about 100 mm or about 10 nm to about 10 mm or about 1 um to about 1,000 um. The microstructure may provide a fluid flow path. For example, the microstructure may, but is not limited to, a channel, a chamber, an inlet, and an outlet, or any combinations thereof. The microstructure may be formed on the surface of the substrate, in the substrate, or formed partially on the surface of the substrate and partially in the substrate. The microstructure of the first surface may be formed by using any known method to form a microstructure in plastics such as injection-molding, photolithography, LIGA process, or any combination thereof.

The method includes physically bringing the first surface treated with the nitrogen plasma into contact with a second surface. The second surface may be a surface of a siloxane-containing material.

The term “siloxane” used herein is used as known in the art. For example, siloxane may have a structure represented by Formula 1:

Si(R₁)(R₂)Oₙ Formula 1

In Formula 1, R₁ and R₂ may be each independently a hydrogen atom or a hydrocarbyl group. Here, n refers to a degree of polymerization and may be, for example, in a range of approximately 1 to 50,000, 1 to 40,000, 1 to 30,000, 1 to 20,000, 1 to 10,000, 1 to 5,000, 1 to 3,000, 1 to 2,000, 5 to 50,000, 10 to 50,000, 50 to 50,000, 100 to 50,000, or 1,000 to 50,000.

The term “hydrocarbyl group” or “hydrocarbyl substituent” used herein refers to a group having a carbon atom directly attached to the remainder of a molecule and having predominantly hydrocarbon character. Examples of the hydrocarbyl group include the following: (i) hydrocarbon substituents, i.e., aliphatic (e.g., alkyl or alkenyl), alicyclic (e.g., cycloalkyl and cycloalkenyl) substituents, aromatic-, aliphatic-, and alicyclic-substituted aromatic substituents, and cyclic substituents in which the ring is completed through another portion of the molecule (for example, any two substituents may together form a ring); (ii) hydrocarbon substituents, i.e., non-hydrocarbon groups that do not alter the predominantly hydrocarbon character of the substituent (e.g., halo (particularly, chloro and fluoro), hydroxyl, alkoxy, mercapto, alkylmercapto, nitro, nitroso, and sulfoxy); and (iii) hetero substituents, i.e., substituents that, while having a predominantly hydrocarbon character, contains an atom other than carbon present in a ring or chain composed of carbon atoms, in which the heteroatom includes sulfur, oxygen, nitrogen, and such substituents as pyridyl, furyl, thienyl, imidazolyl. In general, no more than about 2 or no more than one non-hydrocarbon substituent will be present for every ten carbon atoms in the hydrocarbyl group. Typically, a non-hydrocarbyl substituent will not be present in the hydrocarbyl group.

The hydrocarbyl group may have approximately 1 to 30 carbon atoms. R₁ and R₂ may be each independently an alkyl group, an alkenyl group, or an alkynyl group having approximately 1 to 30, for example, approximately 1 to 20, 1 to 15, 1 to 10, or 1 to 5 carbon atoms. R₁ and R₂ may be a methyl group, an ethyl group, a propyl group, a butyl group, a pentyl group, a hexyl group, a heptyl group, a nonyl group, or a decanyl group.

The siloxane-containing material may include not only siloxane itself but also a material combined with siloxane. For example, siloxane may be combined with a plastic material, in which siloxane is exposed at the surface of the plastic material. The siloxane-containing material may be flexible. The siloxane-containing material may be an elastomer. The siloxane may be polydimethylsiloxane (PDMS) or polyphenylsiloxane.

The siloxane may have a film shape. The film may have a thickness of, for example, approximately 10 to 500 μm, or 100 to 300 μm.

The method may further include applying a pressure to the first surface, second surface, or any combination thereof after contacting the first surface with the second surface.

The method may further include annealing after the contacting. The annealing may be treating the bonded product at approximately 25° C. to 150° C. The annealing may be performed for approximately 2 to 10 hours, for example, approximately 2 to 5 hours.

The method may further include coating the first surface with an organosilane having an alkoxy group before treating the first surface with the nitrogen plasma. The term “organosilane” includes silane having silicon-carbon bond. The organosilane may be a molecule represented by (X₁)(X₂)(X₃)Si(Y), wherein X₁, X₂, and X₃ are each independently selected from the group consisting of a hydrogen atom, an alkoxy group (—OR), and a halogen atom, and at least one of X₁, X₂, and X₃ is an alkoxy group. In the alkoxy group (—OR), R may be a hydrocarbonyl group having approximately 1 to 50 carbon atoms. For example, R may be methyl, ethyl, propyl, isopropyl, and the like. The halogen may be F, Cl, Br, I, or At. Y may be an organic moiety optionally substituted with an organic functional group. The organic moiety may have approximately 1 to 50 carbon atoms. The organic moiety may be an alkyl, alkenyl, or cycloalkyl group. The organic functional group may be an amino group. The organic moiety may be an aminoalkyl group or a polyethyleneimine group. In the aminoalkyl group, the alkyl group may have approximately 1 to 50 carbon atoms. The polyethyleneimine group may be represented by —[CH₂CH₂NH]ₙ—, wherein n is approximately 2 to 100. The alkoxy group (—OR) is hydrolyzed in an aqueous environment to produce a hydroxyl group, and at least one hydroxyl group may be involved in condensation with an —OH group of the surface of the solid support as well as the surface of the adjacent organosilane molecule and remove the —OH group. The aminosilane molecule may be polyethyleneiminetriethoxysilane such as 3-aminopropyltriethoxysilane (APTES), N-(2-aminoethyl)-3-aminopropyltriethoxysilane (EDA), and (3-trimethoxysilyl-propyl)diethylenetriamine (DETA). The organosilane may be coated on a first surface by any suitable method, such as dip coating, spin coating, chemical vapor deposition (CVD), or any combination thereof.

The method may further include bonding a third member to the free surface of the siloxane material of the bonded product by bringing another surface (third surface) of a plastic material treated with nitrogen plasma into contact with the free surface of the siloxane material so as to form a bond. In other words, the siloxane material may be sandwiched between two plastic materials.

The treatment of the third surface with the nitrogen plasma may be performed in the same manner as in the treatment of the first surface or differently. The third surface may be a surface of a plastic material. The plastic may have a hydrophobic or hydrophilic surface, and examples of the plastic may include: polyolefin such as polyethylene, polypropylene, and high density polyethylene (HDPE); thermoplastic elastomer (TPE); elastic polymer; fluoropolymer; polymethylmethacrylate (PMMA); polystyrene; polycarbonate (PC); cyclic olefin co-polymer (COC); polyethylene terephthalate (PET); polyvinyl chloride (PVC); acrylonitrile-butadiene-styrene (ABS); polyurethane (PUR); and any combination thereof.

One or more microstructures may be formed on the whole or a portion of the third surface. As mentioned, a microstructure is not limited to a structure having dimensions of micrometers, but indicates a structure having small dimensions. For example, the microstructure may have at least one cross-section, i.e., diameter, width, and height, having dimensions of approximately 10 nm to 100 mm or 10 nm to 10 mm or 1 um to 1,000 um. The microstructure may provide a fluid flow path. For example, the microstructure may be a channel, a chamber, an inlet, an outlet, or any combination thereof. The microstructure may be formed on the surface of the substrate, in the substrate, or formed partially on the surface of the substrate and partially in the substrate. The microstructure of the first surface may be formed by using any known method to form a microstructure in plastics such as injection-molding, photolithography, LIGA process, or any combination thereof.

The siloxane-containing material, for example, a siloxane film, may be bonded to the first surface and/or the third surface through the whole substantially contactable surface. That is, the siloxane-containing material, for example, a siloxane, may be a simple film without having a microstructure. The siloxane-containing material, for example, a siloxane film, may also be bonded to the first surface and/or the third surface through a partial surface.

The bonded product may be a microfluidic device. The microfluidic device may be a device including at least one microstructure. The “microstructure” may be as described above. The microfluidic device may be a microfluidic device having an inlet and an outlet which are connected to each other via at least one channel. The microfluidic device may further include an additional structure, such as a valve, a pump, and a chamber.

The microfluidic device may include a first plastic substrate having a first surface on which a pneumatic channel is formed, a second plastic substrate having a third surface on which a fluidic channel is formed, and a siloxane-containing material, for example, a siloxane film, disposed between the first surface of the first plastic substrate and the third surface of the second plastic substrate. When a pressure or vacuum is applied to the pneumatic channel, the film is deflected or bent to control the flow of a fluid in the fluidic channel. For instance, in one embodiment, the film normally (in a neutral position) blocks the flow of the fluid in the fluidic channel. When a pressure or vacuum is applied to the pneumatic channel, the film is deflected or bent away from the channel to allow the fluid to flow in the fluidic channel. The microfluidic structure may further include an additional surface and film. The additional surface may be a surface to provide a path for the flow of the fluid. The second plastic substrate may include a plurality of bias channels to provide a path for the flow of the fluid. The microfluidic structure may include a plurality of valves formed using the film and aligned as a portion of the pump.

The microfluidic device may include a first plastic substrate having a surface on which a pneumatic channel is formed, a second plastic substrate having a surface on which a fluidic channel is formed, and a siloxane-containing material, for example, a siloxane film, disposed between the respective surfaces of the first plastic substrate and the second plastic substrate. When a pressure or vacuum is applied to the pneumatic channel, a plurality of valves that are pneumatically switchable may be activated, in which the pneumatically switchable valves may control the flow of the fluid in the microfluidic device. In this regard, the first plastic substrate includes a plurality of etched channels, and the etched channels may play a role of dispersing a pressure applied to the film. In the device, three consecutive pneumatically switchable valves may form a pump. The three valves may include an input valve, a diaphragm value, and an output valve.

According to another aspect of the present invention, a structure includes a plastic and a siloxane-containing material bonded to each other prepared according to the method described above. The structure may include a pneumatic valve, a chamber, an inlet, an outlet, or any combination thereof.

According to another aspect of the present invention, a microfluidic device includes the structure. The structure is a structure prepared according to the method described above. In the microfluidic device, the siloxane-containing material may be a siloxane film bonded to the surface of a third substrate on which a microstructure is formed. The siloxane is as described above. The siloxane film mediates the bonding of the first surface and the third surface and extends according to the pressure of the pneumatic valve so as to allow or block the flow of the fluid.

In the microfluidic device, the siloxane-containing material may be a polysiloxane film, and the polysiloxane film is bonded to the third surface treated with nitrogen plasma on which a microstructure is formed.

According to another aspect of the present invention, a microfluidic device is provided, which includes a first plastic substrate having a first surface, a second plastic substrate having a second surface, and a polysiloxane layer disposed between the first substrate and the second substrate, in which the polysiloxane layer is bonded to the first surface of the first substrate and the second surface of the second substrate.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

### Example 1

### Bonding Polystyrene Substrate and PDMS Film by Nitrogen Plasma

A polystyrene substrate was treated with nitrogen (N₂) plasma, and the surface of the nitrogen plasma-treated polystyrene substrate was physically made to contact a PDMS film to bond them.

(1) Plasma Treatment of Polystyrene Substrate

A polystyrene substrate (having a rectangular shape with a size of approximately 6 cm×3 cm and a thickness of about 1 cm) was added to a chamber of a plasma-providing device (Covance-MP, Femto Science, Inc.), and N₂ plasma was provided thereto at room temperature (at about 15° C. to about 35° C.) for about 30 seconds to contact the N₂ plasma with the polystyrene substrate. The N₂ plasma treatment was performed at room temperature, a pressure of about 100 mTorr, a nitrogen flow rate of about 1 sccm, a treatment time of about 30 seconds, and a plasma voltage ranging from approximately 20 to 50 Watt.

As a control, a polystyrene substrate having the same shape and size as the above substrate was added to the chamber of the same plasma-providing device, and O₂ plasma was provided thereto at room temperature (at about 15° C. to 35° C.) for about 30 seconds.

X-ray photoelectron spectroscopy (XPS) analysis was performed for the plasma-treated polystyrene substrate. A wide-scan survey spectrum of all elements of the polystyrene substrate was obtained by using an X-ray photoelectron spectroscope (Quantum 2000 XPS, Physical Electronics Inc.) (Pass energy: 187.25 eV, step: 1 ev, time: 5 minutes).

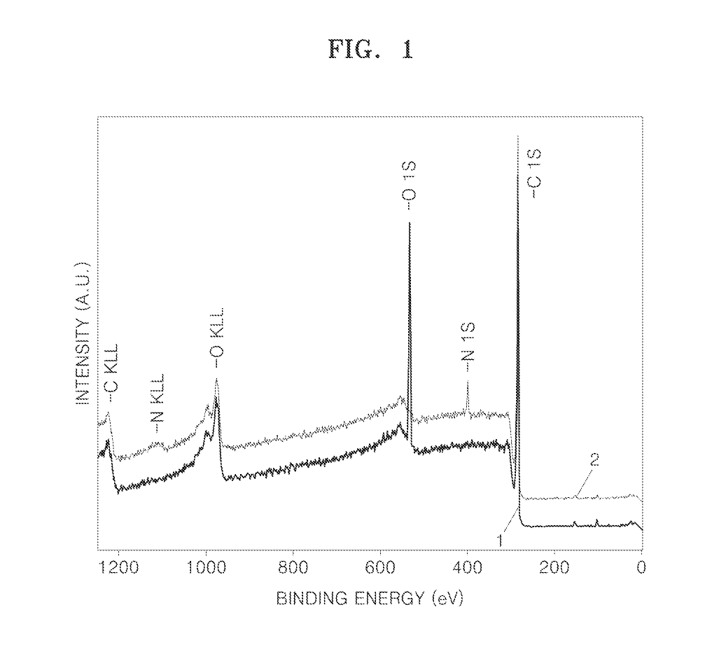

FIG. 1 is a graph illustrating wide-scan survey spectrum of a polystyrene substrate treated with plasma by using an X-ray photoelectron spectroscopy (XPS).

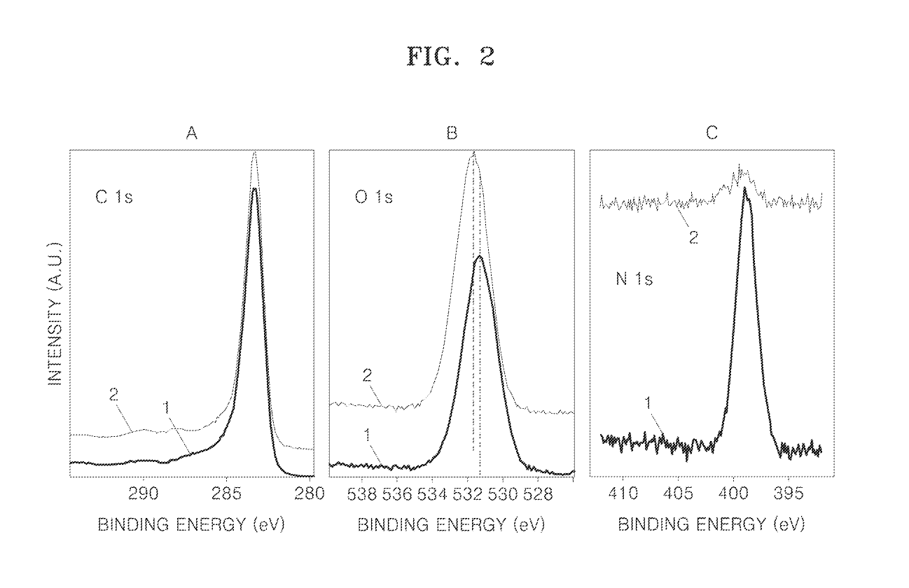

FIG. 2 shows graphs illustrating results of analyzing contents of carbon (A), oxygen (B), and nitrogen (C) of a polystyrene substrate treated with plasma by using an XPS. FIG. 2 shows results of high resolution core level analyses. In FIGS. 1 and 2, 1 indicates a nitrogen plasma treatment, and 2 indicates an oxygen plasma treatment.

As shown in FIGS. 1 and 2(B), the content of oxygen increases by the plasma treatment. This indicates that oxygen is bonded to polystyrene by the plasma treatment. During the nitrogen plasma treatment, a small amount of oxygen contained in the polystyrene substrate is discharged, so that oxygen bond is formed on the surface thereof. However, the scope of the present invention is not limited to particular mechanism. As shown in FIGS. 1 and 2(C), the content of nitrogen increases by the nitrogen plasma treatment. This indicates that nitrogen is bonded to polystyrene by the nitrogen plasma treatment. Contents of elements obtained by the XPS analysis are as follows.

TABLE 1

| | Carbon | Nitrogen | Oxygen |
|---|---|---|---|
| Treatment | (C1s)(%) | (N1s)(%) | (O1s)(%) |
| Nitrogen plasma | 80.98 | 4.15 | 14.88 |
| Oxygen plasma | 81.11 | 0.68 | 18.21 |

(2) Bonding Plasma-Treated Polystyrene Substrate and PDMS

The surface of the polystyrene substrate treated with the plasma in operation (1) above was brought in contact with a PDMS film and bonded thereto to prepare a polystyrene (PS) substrate-PDMS film structure (hereinafter, referred to as “PS-PDMS structure”).

Particularly, a PDMS film (having a width of about 1 cm, a length of about 6 cm, and a thickness of about 0.25 mm (about 0.01″) (HT-6240 Performance Solid Silicon), Rogers Corporation, USA) was brought in contact with the surface of the PS substrate and annealed at about 55° C. for about 2 hours without applying a pressure thereto.

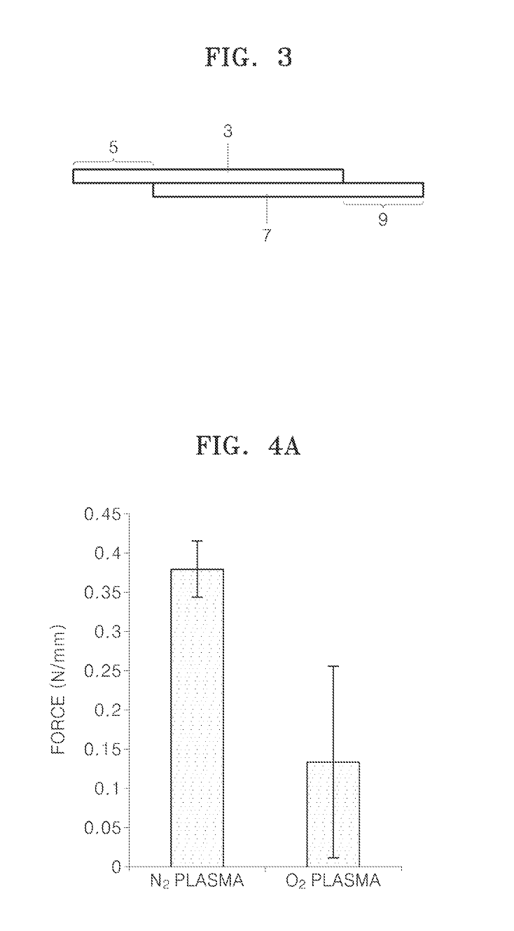

FIG. 3 shows a polystyrene (PS) substrate-polydimethylsiloxane (PDMS) structure prepared according to an embodiment of the present invention. As shown in FIG. 3, the contact does not indicate that a PS 7 and a PDMS 3 completely overlap each other, but one end 5 (about 3 cm in this case) of the PDMS 3 does not contact the PS 7 (PDMS overhang). In the measurement of the bonding intensity, a noncontact portion of the PDMS 3 was fixed using pliers.

The annealing is considered to further improve the bonding between the PS substrate and the PDMS film. However, the annealing is an optional process. Even when the annealing process was not performed, the bonding intensity was sufficiently strong. The annealing may be a treatment of the bonded product at approximately 25° C. to 150° C. The annealing may be performed for approximately 2 to 10 hours.

Resistance against hydrolysis of the prepared PS-PDMS structure was measured. The measurement was performed by immersing the PS-PDMS in deionized (DI) water and maintaining it at the room temperature for about 1 hour. Then, while the PS-PDMS structure is fixed, the PDMS overhang 5 was pulled upward at a rate of about 10 mm/min to measure force applied to the bonding surface between the PDMS and PS (Device: High Precision Materials Testing System 5948, Instron Inc.).

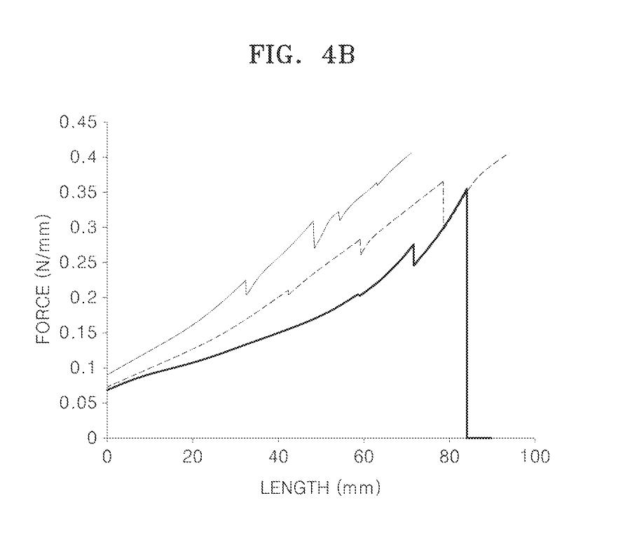

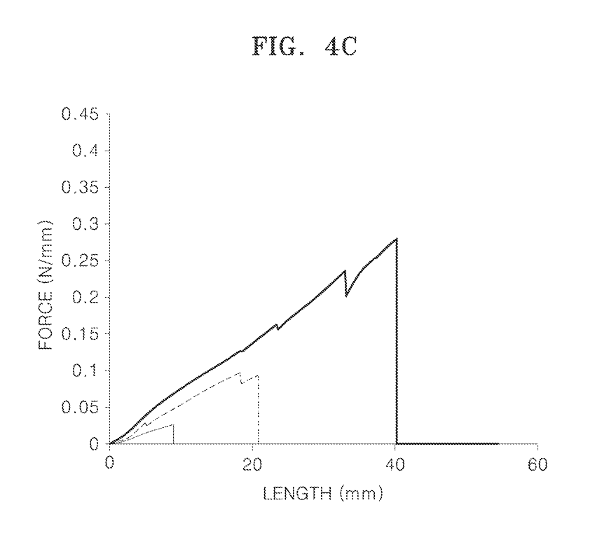

FIGS. 4A, 4B, and 4C are graphs illustrating results of testing bonding intensities after immersing PS-PDMS structures prepared according to an embodiment of the present invention (4B) and a control PS-PDMS structure (4C) in water. Particularly, FIG. 4A is a graph illustrating bonding intensity variation after hydrolysis for about 1 hour. FIGS. 4B and 4C are graphs illustrating bonding intensities of PDMS-PS structures respectively prepared by nitrogen plasma treatment (FIG. 4B) or oxygen plasma treatment (FIG. 4C). In FIGS. 4B and 4C, the length in x axis refers to the length that the PDMS overhang 5 was pulled upward. The force in y axis refers to the measured force per the width of the testing sample while the PDMS was pulled upward. FIGS. 4B and 4C show results of samples 1, 2, and 3 (three samples of nitrogen-plasma and oxygen-plasma bonding, respectively, indicated by different lines on each graph) immersed in water for about 60 minutes. As shown in FIGS. 4A, and 4B, the PS-PDMS structure prepared by the treatment of nitrogen plasma maintained the same bonding intensity as that before being immersed in water.

These results illustrate that nitrogen plasma treated plastic—such as polystyrene—bonded to an elastomer—such as a PDMS film—exhibits greater resistance to hydrolysis than oxygen plasma treated plastic bonded to an elastomer. The oxygen plasma treatment introduces oxygen into the carbon of the plastic, which bonds to an atom of the elastomer to form the plastic-elastomer structure. The introduced oxygen is easily decomposed by hydrolysis. On the other hand, nitrogen plasma treatment of the plastic introduces nitrogen into the carbon of the plastic, which bonds to an atom of the elastomer to form the plastic-elastomer structure. The introduced nitrogen is more resistant to decomposition by hydrolysis than the introduced oxygen.

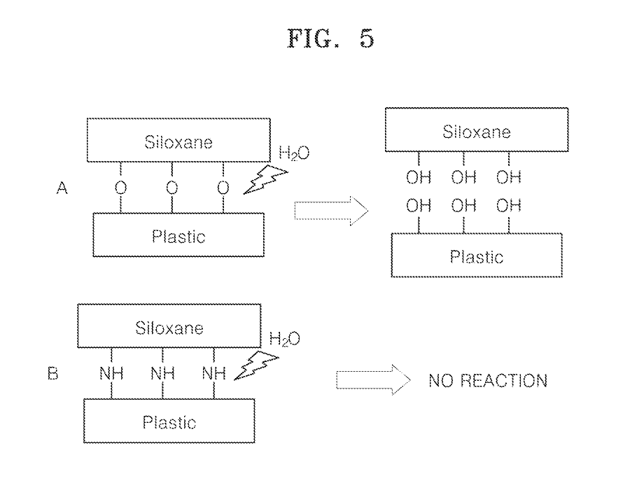

FIG. 5 schematically shows resistance against hydrolysis of a PDMS-PS bonding formed by the treatment of nitrogen plasma or oxygen plasma. In FIG. 5, reference characters “A” and “B” show hydrolysis of the PDMS-PS bonds formed respectively by oxygen plasma treatment and nitrogen plasma treatment in water. As shown in FIGS. 5A and 5B, the PDMS-PS bond formed by oxygen plasma treatment includes —O— bonds which are decomposed by the addition of water (5A), but the PDMS-PS bond formed by nitrogen plasma treatment includes —NH— bonds which are not decomposed by the addition of water (5B). These examples are for illustrative purposes only and are not intended to limit the scope of the invention.

### Example 2

### Preparation of Microfluidic Structure Using Nitrogen Plasma

FIG. 6 shows a method of preparing a microfluidic structure according to an embodiment of the present invention.

As shown in FIG. 6, the method provides a first substrate 20 and a second substrate 30. The first and second substrates 20 and 30 may have one or more microstructures which may be prepared by any known method such as injection-molding or photolithography. The first and second substrates 20 and 30 may be plastic, and the microstructure may be prepared by injection-molding. Then, surfaces of the first and second substrates having the microstructure are treated with nitrogen plasma 50. The surface treatment may be performed by providing N₂ plasma thereto. Then, polysiloxane 40 is aligned between the surfaces treated with the nitrogen plasma 50, and they are bonded by applying a pressure thereto or annealing the resultant to prepare a microfluidic structure.

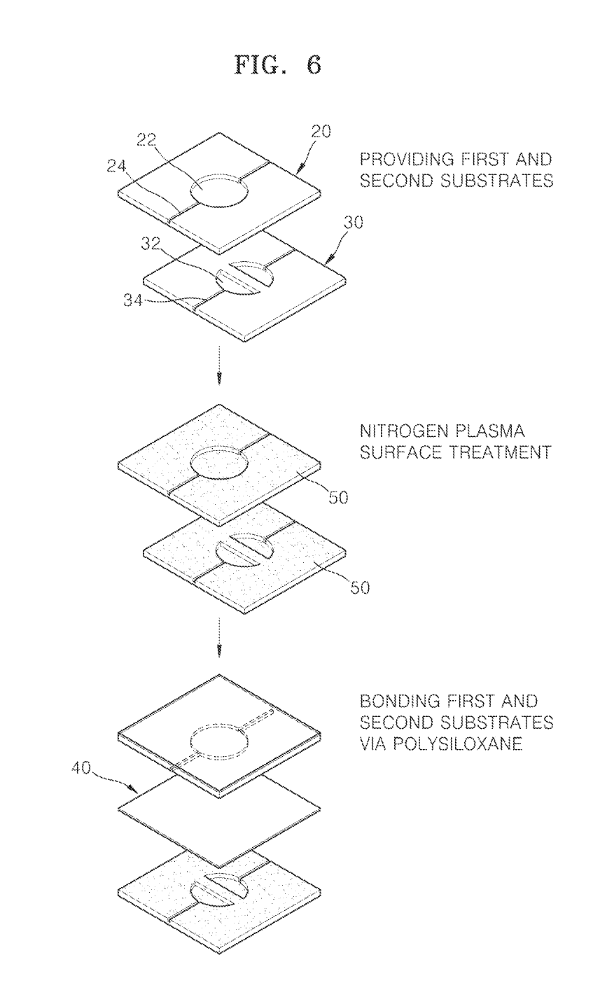

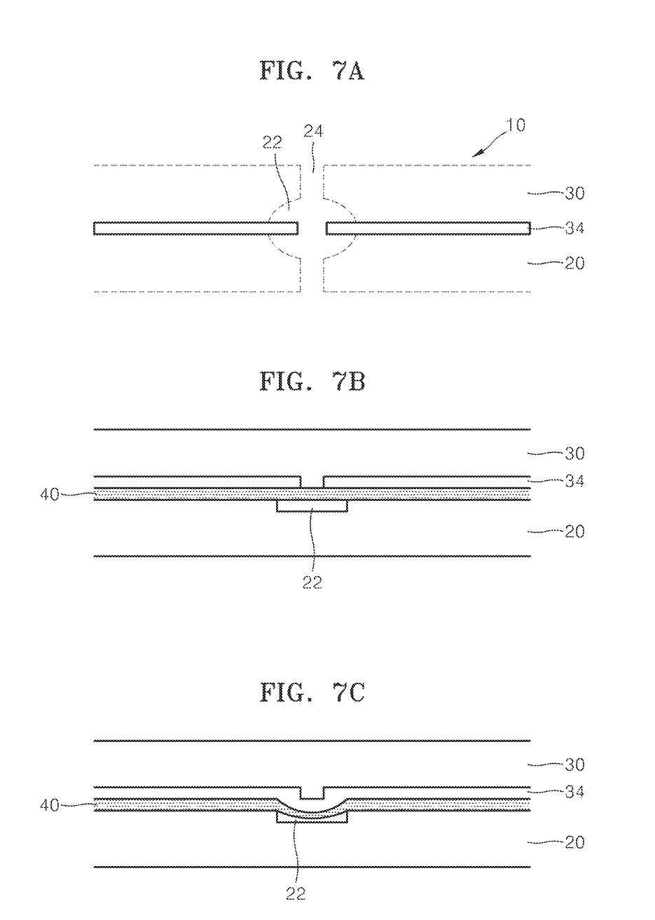

In the microfluidic structure prepared according to FIG. 6, one or more microstructures may include a pneumatic channel 24 and a pneumatic valve 22 formed on the first substrate 20, and a fluidic channel 34 and a fluid valve 32 formed on the second substrate 30, and the pneumatic valve 22, polysiloxane film 40, and fluid valve 32 may function as a diaphragm valve or a pump by the bonding of the first and second substrates. The microstructure functioning as a pump or valve will be described with reference to FIGS. 7A to 7C.

FIGS. 7A to 7C schematically show a microfluidic structure according to an embodiment of the present invention. FIGS. 7A to 7C schematically show a film valve employed in a microfluidic device. FIG. 7A is a plan view of a film valve, and FIGS. 7B and 7C are side views of a film valve that is closed and opened, respectively. The microfluidic structure includes a polysiloxane film 40 disposed between two plastic substrates 30 and 20. The polysiloxane film may be HT-6135 and HT-6240 having a thickness of 254 μm purchased from Bisco Inc. The polysiloxane film is strongly bonded to the surfaces of the two substrates surface-treated with nitrogen plasma. The fluidic channel 34 may be used to convey a fluid. The pneumatic channel 24 and the valve region 22 are etched under a pressure or in a vacuum to convey air or another fluid by activating the valve. In general, the pneumatic channel 24 and the valve region 22 are disposed on one substrate 20 (hereinafter, referred to as “pneumatic substrate”), and the fluidic channel 34 is disposed on the other substrate 30 (hereinafter, referred to as “fluidic substrate”). The pneumatic substrate may have a port providing pressure or vacuum to the pneumatic channel.

A control mechanism of the valve shown in FIGS. 7A to 7C will be described. An activating vacuum is provided to the valve region 22 of the polysiloxane film 34 via the pneumatic channel. The vacuum applied thereto bends the polysiloxane film 34 away from a discontinuous region of the fluidic channel to provide a path that allows the flow of a fluid. Thus, the valve is open as shown in FIG. 7C. The valve that may be open or closed by using air pressure refers to a switchable valve or pneumatically switchable valve. If vacuum or pressure is not applied, the film closes the fluidic channel as shown in FIG. 7B.

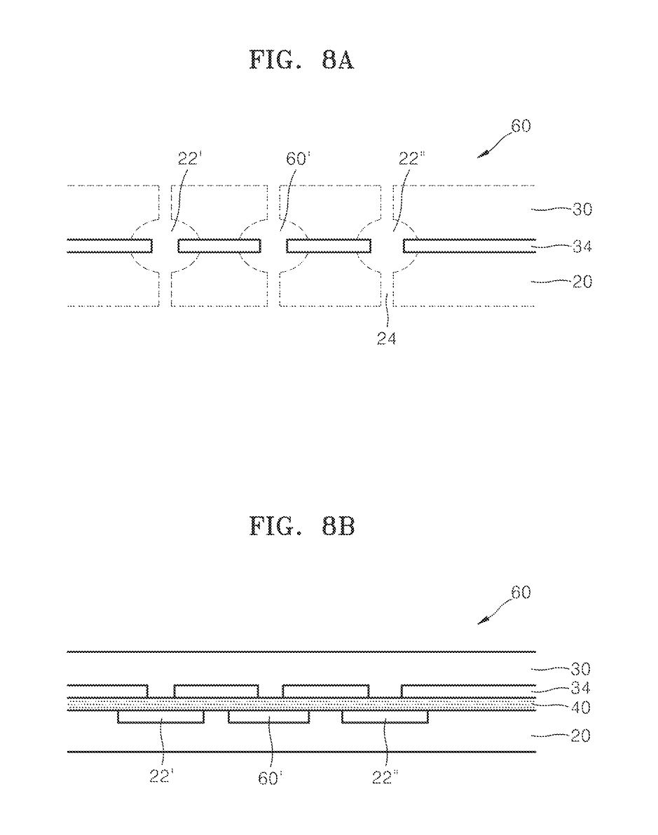

The film valve may be used for various fluid control mechanisms. FIGS. 8A and 8B schematically show a pump formed using film valves according to an embodiment of the present invention. FIGS. 8A and 8B show a plan view and a side view of a film pump, respectively. As shown in FIGS. 8A and 8B, three film valves that are consecutively aligned form a diaphragm pump 60. A pumping is performed by activating the valves according to 5 cycles. The diaphragm pump 60 includes an input valve 22′, a diaphragm valve 60′, and an output valve 22″. Since the diaphragm pump 60 may operate in any direction, the terminologies of the input valve 22′ and output valve 22″ are optional. The pump includes a fluidic substrate 30 having an etched fluidic channel 34, a polysiloxane film 40, and a pneumatic substrate 20. The polysiloxane film 40 is bonded to the fluidic substrate 30 and the pneumatic substrate 20 through a nitrogen plasma layer.

The pumping may be performed in a series of operations. In a first operation, the output valve 22″ is closed and the input valve 22′ is open. In a second operation, the diaphragm valve 60′ is open. In a third operation, the input valve 22′ is closed. In a fourth operation, the output valve 22″ is open. In a fifth operation, the diaphragm valve 60′ is closed, and the fluid is pumped via the open output valve 22″. The film valve may function as a pump, a mixer, a router, or the like.

As described above, according to the method of bonding two surfaces, two surfaces may be efficiently bonded to each other. In addition, the bonded product has excellent resistance against hydrolysis. In addition, since the surface of plastic to be processed is efficiently bonded, various structures may be efficiently formed, and manufacturing costs may be reduced.

The structure and the microfluidic device including the structure according to the present invention have excellent resistance against hydrolysis.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of bonding two surfaces, the method comprising:
treating a surface of a plastic material with nitrogen plasma; and
contacting the surface of the plastic material treated with the nitrogen plasma with a surface of a siloxane-containing material,
whereby the surface of the plastic material is bonded to the surface of the siloxane-containing material.

2. The method of claim 1, wherein the surface of the plastic material treated with the nitrogen plasma is directly contacted with the surface of the siloxane-containing material, without an intervening adhesive layer.

3. The method of claim 1, wherein the bond formed by bringing the surface of the plastic material treated with the nitrogen plasma into contact with the surface of the siloxane-containing material has higher resistance against hydrolysis than a bond formed by bringing a surface of a plastic material treated with an oxygen plasma into contact with a surface of a siloxane-containing material.

4. The method of claim 1, further comprising coating the surface of the plastic material with an organosilane compound having an alkoxy group before treating with the nitrogen plasma.

5. The method of claim 1, wherein the treatment with nitrogen plasma is performed by applying an electromagnetic field to nitrogen or ammonia molecules to generate plasma at about 100° C. or less, and contacting the surface with the plasma.

6. The method of claim 1, wherein the plastic is polyolefin, thermoplastic elastomer (TPE), elastic polymer, fluoropolymer, polymethylmethacrylate (PMMA), polystyrene, polycarbonate (PC), cyclic olefin co-polymer (COC), polyethylene terephthalate (PET), polyvinyl chloride (PVC), acrylonitrile-butadiene-styrene (ABS), polyurethane (PUR), or any combination thereof.

7. The method of claim 1, wherein the siloxane is a polymer of a repeating unit represented by Si(R₁)(R₂)Oₙ, wherein R₁ and R₂ are each independently a hydrogen atom or a hydrocarbyl group and n is an integer of 1 to 50,000.

8. The method of claim 1, wherein the siloxane is polydimethylsiloxane (PDMS) or polyphenylsiloxane.

9. The method of claim 1, further comprising applying pressure to the surface of the plastic material, the surface of the siloxane material, or any combination thereof, after contacting the surface of the plastic material with the surface of the siloxane-containing material.

10. The method of claim 1, further comprising annealing after contacting the surface of the plastic material with the surface of the siloxane-containing material.

11. The method of claim 1, wherein a microstructure is formed on the whole surface or a portion of the surface of the plastic material.

12. The method of claim 1, further comprising treating a surface of a second plastic material with nitrogen plasma, and contacting the treated surface of the second plastic material with a surface of the siloxane-containing material opposite the surface bonded to the first plastic material, whereby the surface of the second plastic material is bonded to the siloxane-containing material to provide a bonded product in which the siloxane-containing material is disposed between a first and second plastic materials.

13. The method of claim 12, wherein a microstructure is formed on the whole or a portion of the surface of the second plastic material.

14. The method of claim 13, wherein the plastic is polyolefin, thermoplastic elastomer (TPE), elastic polymer, fluoropolymer, polymethylmethacrylate (PMMA), polystyrene, polycarbonate (PC), cyclic olefin co-polymer (COC), polyethylene terephthalate (PET), polyvinyl chloride (PVC), acrylonitrile-butadiene-styrene (ABS), polyurethane (PUR), or any combination thereof.

15. The method of claim 12, wherein the bonded product is a microfluidic device.

16. A structure manufactured by the method of claim 1.

17. A microfluidic device comprising the structure of claim 16.

18. The microfluidic device of claim 17, wherein the siloxane-containing material is a siloxane film bonded to a surface of a third substrate on which a microstructure is formed.

19. The microfluidic device of claim 17, wherein the siloxane-containing material is a polysiloxane film, wherein the polysiloxane film is bonded to a surface of a third substrate treated with nitrogen plasma on which a microstructure is formed.

20. A microfluidic device comprising:
a first plastic substrate having a first surface;
a second plastic substrate having a second surface; and
a polysiloxane layer disposed between the first substrate and the second substrate,
wherein the polysiloxane layer is bonded to the first surface of the first substrate and the second surface of the second substrate, and the bonded surfaces of the plastic substrates have a surface nitrogen content that is greater than the surface nitrogen content of the non-bonded surfaces.

21. The microfluidic device of claim 20, wherein the bonded surfaces of the plastic substrates have a surface nitrogen content of about 2% or greater as measured using X-ray photoelectron spectroscopy.

22. The microfluidic device of claim 21,
wherein the device does not comprise an adhesive layer between the first surface and the polysiloxane layer, or between the second surface and the polysiloxane layer.
